(19) United States
(12) Patent Application Publication
(10) Pub. No.: US 2009/0307073 A1
(43) Pub. Date: Dec. 10, 2009

(54) SOCIAL MARKETING

(75) Inventors: Vahab MirrokniBanadaki, Redmond, WA (US); Jason Daniel Hartline, Evanston, IL (US); Mukund Sundararajan, Stanford, CA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/136,070

(22) Filed: Jun. 10, 2008

(51) Int. Cl. G06Q 10/00

(52) U.S. Cl. 705/14.25; 705/1

(57) ABSTRACT

The described implementations relate to social marketing. One technique identifies potential buyers of a product, the potential buyers belong to a social network. The technique determines a price to offer the product to individual potential buyers that considers both influence of the individual potential buyer within the social network and overall revenue from sales of the product to the potential buyers.

### BACKGROUND

Social network settings are increasingly common in society. For example, social networks exist in the bricks-and-mortar realm of a monthly book club that meets at the local bookstore. In another example, the Internet lends itself to social networks, such as chat rooms and social sites. Many users find socializing via the Internet to be both convenient and effective for interacting with others of similar interest. A commonality of social networks is that members of the social network tend to influence one another's behavior. Thus, a social network can be thought of as a set of members (i.e., people) where at least some members tend to influence at least some other members and at least some members are influenced by other members. Influence among the members tends to be uneven or disproportionate. For instance, some members tend to be relatively more influential and other members tend to be relatively less influential.

User or member information is readily collectable from social networks especially Internet-based social networks. Member information can include who is acquainted with whom, how frequently they interact online, what interests they have in common, etc. Further, members are spending increasing amounts of time on social network websites and thus the effect of the social networks becomes magnified relative to other activities.

Marketing to social networks can be productive for at least a couple of reasons. First, a product can be targeted to social networks that tend to be interested in the product. For instance, video games can be marketed to a web-site based social network dedicated to gaming. Second, since at least some members of the social network influence other members, once introduced to these key influential members, the social network can potentially ‘self-market’ the product. This self-marketing aspect can be thought of as viral marketing since one member's use and satisfaction with the product tends to be conveyed to other members and influences the other members' perception of the product. Various issues surrounding marketing to social networks are discussed below.

### SUMMARY

The described implementations relate to social marketing. One technique identifies potential buyers of a product where the potential buyers belong to a social network. The technique determines a price to offer the product to individual potential buyers that considers both influence of the individual potential buyer within the social network and overall revenue from sales of the product to the potential buyers.

Another implementation identifies potential buyers of a product in a social network. The implementation arbitrarily selects a set of the potential buyers to offer the product at a relatively low price to influence the remaining potential buyers. The implementation also updates membership in the set by adding and removing individual potential buyers from the set until revenue from product sales to the social network is not increased by adding or removing an individual potential buyer from the set. The above listed examples are intended to provide a quick reference to aid the reader and are not intended to define the scope of the concepts described herein.

### BRIEF DESCRIPTION OF THE DRAWINGS

The accompanying drawings illustrate implementations of the concepts conveyed in the present application. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the Figure and associated discussion where the reference number is first introduced.

FIGS. 1-3 illustrate exemplary systems for social marketing in accordance with some implementations of the present concepts.

FIG. 4 illustrates an exemplary technique for social marketing in accordance with some implementations of the present concepts.

FIG. 5 illustrates an example of an exemplary social network environment for implementing the present concepts in accordance with some implementations.

FIGS. 6-7 illustrate data related to social marketing in accordance with some implementations of the present concepts.

FIGS. 8-9 are flow diagrams of exemplary methods relating to social marketing in accordance with some implementations of the present concepts.

### DETAILED DESCRIPTION

### Overview

The present concepts relate to social marketing, i.e., product marketing in social networks or settings. The concepts further relate to revenue generation resulting from the social marketing. In some implementations, revenue generation resulting from the social marketing is considered from an overall perspective as the revenue generated from offering the product to each of the members. In considering overall revenue generation, the present concepts recognize that within a social network, individual members tend to have disproportionate influence on other members. For instance, some members tend to be relatively more influential and other members tend to be relatively less influential. In this light, some of the present implementations can distinguish relatively more influential members from relatively less influential members.

Some implementations can offer the product to individual members in an order based, at least in part, on their relative influence. Further, the concepts can determine a price to offer the product to individual members. The price can be based on their relative influence, among other considerations. The order of offering and the price of offering can both affect revenue generation from the overall perspective. For instance, overall revenue can be increased by offering the product to relatively more influential members first since they tend to exert more influence on subsequent perceptions and/or behavior of other members. Further, in some instances, reducing the offering price to the relatively influential members at an early stage in the process can positively affect overall revenue due to their influence on the other members. For example, getting the product into the hands of the relatively influential members can influence the perception of other members to such a degree that the other members are willing to pay a higher price for the product than would otherwise be the case.

### Exemplary Systems

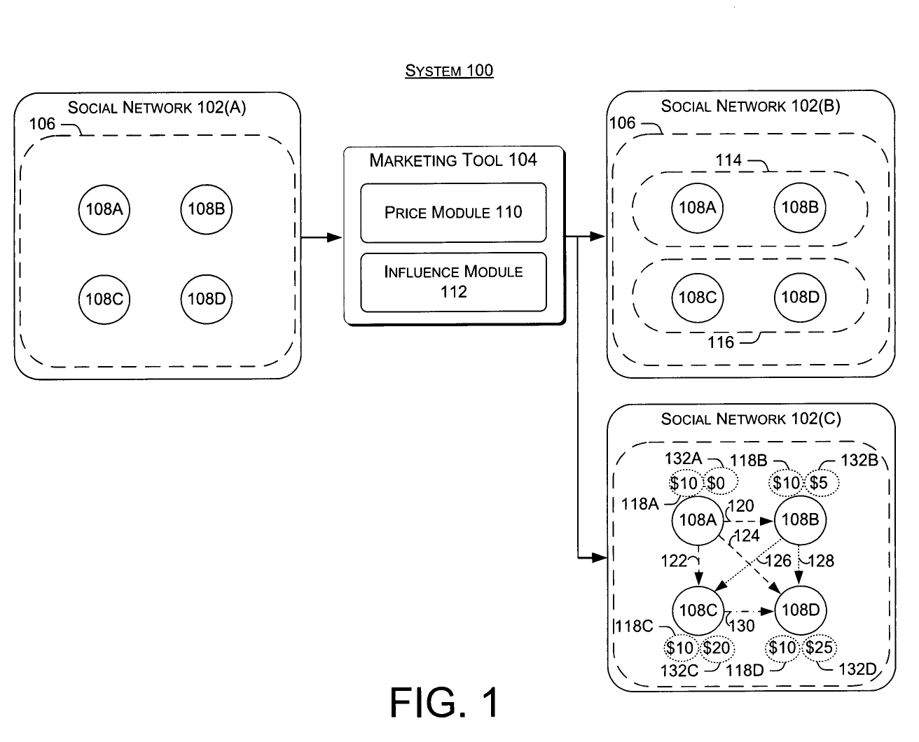

FIG. 1 involves a social marketing system 100 that considers overall revenue from the sale of a product. In this scenario, system 100 includes a social network 102 and a marketing tool 104. The social network is shown before and after processing by marketing tool 104. Accordingly, the social network is designated before processing as 102(A) on the left side of the physical page on which FIG. 1 appears and in two subsequent renditions after processing as 102(B) and 102(C) on the right side of the page.

Social network 102 includes a set of members 106. In this case, the set entails four individual members 108A, 108B, 108C, and 108D. Further, marketing tool 104 includes a price module 110, and an influence module 112. In this discussion, members can be thought of as potential buyers in that upon receiving an offer for a product, an individual member either buys or adopts the product (i.e., becomes a buyer) or rejects the offer and becomes a non-buyer.

For introductory purposes, consider a seller interested in selling a specific product such as a good or service. A sale to one buyer often has an impact on other potential buyers. Such an effect is called the externality of the transaction. Externalities that induce further sales and revenue for the seller are called positive externalities. For instance, when influential members own a copy of a product, other members can assess its quality before making a decision to buy. With high quality products, this influences the other member to buy the product and even increases how much he/she is willing to pay for it.

System 100 can be utilized to market various types of products. Generally, profit from sales of a product can be thought of as revenue minus costs. For some types of products, once the product exists additional copies of the product can be made for little or no additional cost. One example of this type of product is digital products, such as software applications. Once a software application is created additional copies of the software application can be generated for little or no cost. In such a case, in practical terms an additional sale increases revenue and revenue approximately equals profits.

For ease of explanation, the discussion below is directed to these types of products where creating an additional copy of the product has nominal costs. In such cases, the calculations are easier since the production costs associated with an additional sale essentially fall out leaving revenue as the sole discussion point. The present concepts can also be applied to other types of products, though the calculations can become more complex and as such these products are not discussed for sake of brevity.

In the present circumstance, marketing tool 104 functions to market a product to members 108A-108D of social network 102 on behalf of the seller. The marketing tool 104 can market the product in a manner that addresses overall revenue from sales to individual members 108A-108D. Some implementations can simply address overall revenue as a consideration in the marketing process. Other implementations can attempt to enhance overall revenue from the marketing process and some of these particular implementations can attempt to maximize the overall revenue. Marketing tool 104 considers overall revenue in regard to both price and influence related to individual members as will be described below.

To introduce the reader to the present concepts a qualitative example that addresses overall revenue is now presented in relation to marketing tool 104. As mentioned above, members of a social network tend to have disproportionate levels of influence on other members. Early adoption of a product by relatively influential members can increase the perceived value of other members and thereby a price that they may be willing to pay for the product.

In recognition of overall revenue, the marketing tool 104 can consider both price and influence factors in marketing the product to the member 108A-108D of social network 102. The marketing tool can utilize the price and influence factors to determine an order of offers to the members and a price of the offer to each member. In this light, some implementations of the marketing tool can be thought of as functionally dividing the members into two groups or sub-sets of overall members of the social network. Such as scenario can be seen relative to social network 102(B). In this instance, a first group or set 114 can contain the relatively influential early adopters. Another group or set 116 can contain the remaining members. (Techniques for identifying the two groups are discussed below in relation to social network 102(C).)

Stated generally, the marketing tool 104 can weight the influence factors higher for the first group 114 and thereby lower the price to encourage purchasing of the product by the influential members to potentially increase subsequent sales to the second group 116. For the second group 116, the marketing tool 104 can weight price over influence to increase revenue from individual sales to the second group. Thus, the marketing tool 104 can potentially forgo some potential revenue from the first group 114 to potentially increase revenue from the second group 116.

Social network 102(C) offers another example of how marketing tool 104 can consider influence data and price data to develop a marketing strategy that addresses overall revenue. In this implementation, price module 110 can generate the price data for the marketing tool 104. Similarly, influence module 112 can generate the influence data. The price module 110 can serve to predict or estimate a probability that an individual member will buy the product at a given price. In some cases, the price data can reflect at what price an individual member may buy the product in a particular circumstance at a given probability. For ease of explanation in the present example assume that the price data indicates that each of members 108A-108D will pay $10 for the product with a hypothetical likelihood or probability X as indicated at 118A, 118B, 118C, and 118D, respectfully.

Influence module 112 can determine relative degrees of influence among members 108A-108D. In some implementations, influence can mean both forward-looking (i.e., future) influence and rearward looking (i.e., past influence) between individual members. Forward looking influence can be thought of as the influence that an individual member exerts on other members. Rearward looking influence can be thought of as influence exerted on an individual member by other members. Consider the example of social network 102(C) where the influence data indicates that member 108A influences members 108B, 108C, and 108D as identified by dashed lines 120, 122, and 124 respectively. Similarly, member 108B influences members 108C and 108D as indicated by dotted arrows 126, 128 respectively. Finally, member 108C influences member 108D as indicated by dashed/dotted arrow 130. In this case, member 108D does not influence any other members.

The marketing tool 104 can determine an order in which to offer the product and an offer price for each member based upon the price data and influence data described above. In this case, assume that the marketing tool selects the order based on influence starting with member 108A then member 108B, member 108C, and then finally member 108D.

Further, assume that the marketing tool 104 generates offer prices that are adjusted from the pricing data in light of the relative influence of the members. For instance, member 108A has the highest level of influence in the present example. Accordingly, early adoption (i.e., purchase) of the product is weighted for member 108A. Remember that the price module 110 indicated that member 108A is likely to buy the product for $10 as indicated at 118A. However, assume that the marketing tool considers the influence of member 108A and generates a discounted offer price of $0 (i.e, free) as indicated at 132A. In this case, to ensure early adoption by influential member 108A this member receives the first offer and the offer is at a price that is below what the member is likely to be willing to pay. In this example, the price was lowered to such a degree that the product was offered for free. Some implementations may even take this process another step further and pay highly influential members to become early adopters. For instance, one such case could involve a scenario where the product is competing with an already established product such that there is some degree of inertia built into the social network.

Returning to the above example, assume that after member 108A, that the product is next offered to member 108B at a reduced price of $5 as indicated at 132B. It is likely that member 108B would have paid $10 for the product as indicated at 118B, but again the price was adjusted based upon the member's influence to increase the likelihood of acceptance beyond probability X. In this case, the price offer 132B to member 108B was not reduced as much as the offer to member 108A since the positive influence of member 108A may already be increasing the perceived value of the product to member 108B (and/or the other members 108C, 108D).

Assume further that the marketing tool 104 subsequently offers the product to member 108C at offer price “$20” as indicated at 132C. In this case, the marketing tool 104 selects a higher price than predicted by the price module due to the positive influence of members 108A and 108B. This positive influence can increase the perceived value of the product to members 108C and 108D and thereby increase the amount these members are willing to pay for the product. Each of members 108A-108C influences member 108D and adoption by these members can increase the perceived value to member 108D. Accordingly, the product can be offered to member 108D at a still higher offer price of “$25” as indicated at 132D.

When considering overall revenue, the pricing module indicated probable revenue to be four sales at $10 each (overall revenue of $40) as evidenced by summing prices 118A-118D. However, marketing tool 104 sacrificed some potential revenue from members 108A and 108B to promote early adoption by these influential members. This influence allowed higher offer prices ($20, $25) respectively, to members 108C and 108D. Thus, when viewed as a whole, the revenue (i.e., overall revenue) actually increased from $40 to $50 ($5+$20+$25). For sake of brevity, the current social network has only four members, but the illustrated results can be even more pronounced when applied to relatively large social networks where the early offer price discounts can spawn increased revenue from large numbers of less influential members.

In summary, several concepts are introduced above related to network marketing. Marketing tool 104 considers both offer price and offer order when addressing overall revenue generation from a social network. It should be apparent that there may be trade-offs involved in this type of marketing strategy. For instance, larger price discounts related to the early offers increase a likelihood of influential buyers actually purchasing the product at the cost of potential decreased revenue from sales to these influential buyers. The purpose of these early discounts is to increase subsequent revenue by an amount that more than offsets the discounts. Various algorithms can be directed toward the present concepts and individual algorithms may balance these trade-offs differently.

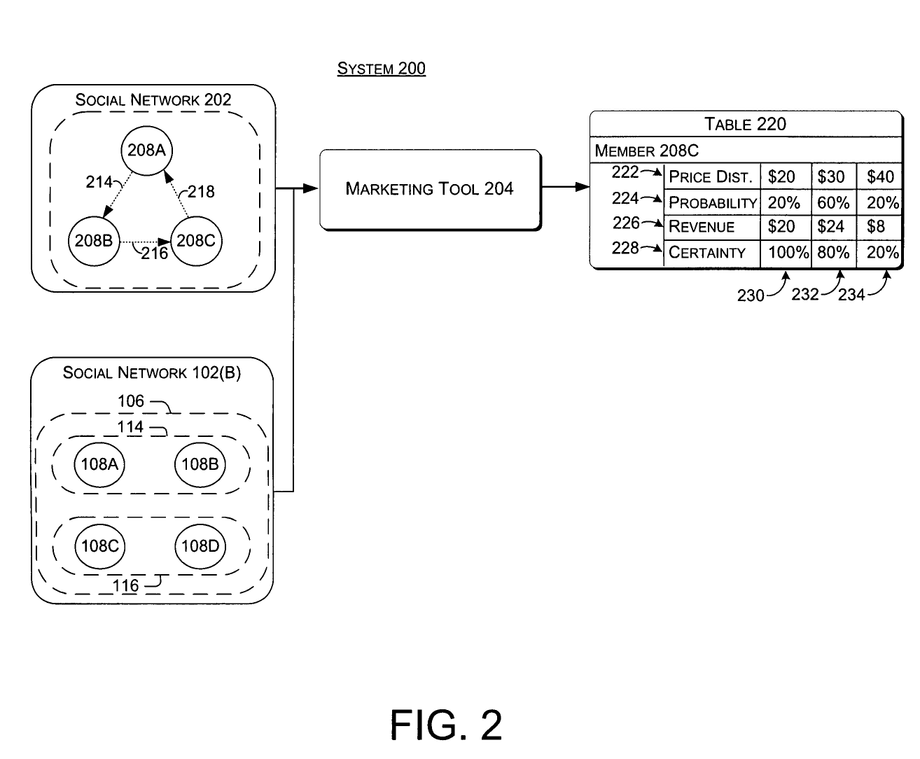

FIG. 2 relates to another system 200 that addresses network marketing. System 200 includes a social network 202 and a marketing tool 204. System 200 includes three members 208A, 208B, and 208C.

While FIG. 1 introduced several broad concepts, FIG. 2 begins by describing pricing techniques for network marketing in a specific scenario or setting illustrated in the setting of social network 202. In this setting, termed a symmetric setting, influence is not considered when calculating pricing data for each of members 208A-208C. Stated another way, when calculating the pricing data, each of the members is considered to have symmetric influence. For example, in social network 202, arrow 214 indicates that member 208A influences member 208B. Arrow 216 indicates that member 208B influences member 208C. In turn, arrow 218 indicates that member 208C influences member 208A. In this situation, the members appear symmetric in that each member influences one other member and is in turn influenced by one other different member. In such a setting a valuable (and potentially optimal) offer price can be calculated for the individual members.

For instance, assume that marketing tool 204 generates a table 220 for member 208C that includes a price distribution row 222, a probability row 224, a revenue row 226, and a certainty row 228. Price distribution row 222 lists prices for member 208C as “$20”, “$30”, and “$40”. Probability row 224 lists the probabilities corresponding to the individual prices as “20%”, “60%” and “20%”. Corresponding revenues are listed in the revenue row as “$20”, “$24”, and “$8” and certainty values of the certainty row 228 are listed as “100%”, “80%” and “20%”. So for instance, a column 230 indicates that at an offer price of “$20” member 208C buys the product with “20%” probability. The revenue generated from such a sale is “$20” as indicated by the intersection of row 226 and column 230. Further, the certainty is “100%” as indicated at the intersection of row 228 and column 230. The certainty is 100% since the probabilities that the member will accept an offer of $20 or more add up to 100%.

Similarly, in relation to the “$30” offer price reflected in price distribution row 222, an intersecting column 232 indicates a probability of “60%” of a revenue of “$24” at a certainty of “80%”. In relation to offer price “$40” of the price distribution row, a column 234 indicates a probability of “20%” of a revenue of “$8” and a certainty of “20%”. It follows then that in the illustrated symmetric configuration of social network 202 the valuable (and potentially) optimal offer price for member 208C is $30. Thus, marketing tool 204 can offer the product to member 208C for $30 to increase (and potentially maximize) revenue at $24 ($30 offer price×80% certainty of acceptance). No other offer price offers more revenue.

This symmetric scenario technique can be applied in two useful settings. For purposes of discussion, FIG. 1's social network 102(b) is reproduced on FIG. 2. Recall from the discussion relating to FIG. 1, that the members of social network 106 were divided into two sets: 114 and 116. Set 114 included the influential members and set 116 included the remaining members. The strategy described above weighted the first set to increase influence and the second set to increase revenue. Once the members of the sets are established some technique can treat members within the set as symmetric for calculating offer prices. In such an instance, the concepts described in relation to table 220 can offer useful information. Recall from the above discussion that an offer price can be derived from table 220 at which there is 100% certainty of acceptance by the member. This information can be useful to determine how much to discount the offer prices to members 108A and 108B of the first set 114 to increase and potentially ensure acceptance. For instance, assume that the data of table 220 relates to members of the first set. In such a case, an offer discounted to $20 to members 108A and 108B should be accepted with 100% certainty.

Similarly, under the assumption that table 220 applies to members of the second set, then revenue can potentially be optimized with an offer of $30 to members 108C and 108D of second set 116. In summary, another way to consider the concepts described above is that once membership of the first and/or second sets is determined, then the symmetric technique can be applied within a set without further regard to influence within the sets. The data can simply be applied to optimize certainty or revenue. Further details regarding the concepts introduced in relation to FIG. 2 can be found below under the heading “symmetric settings”.

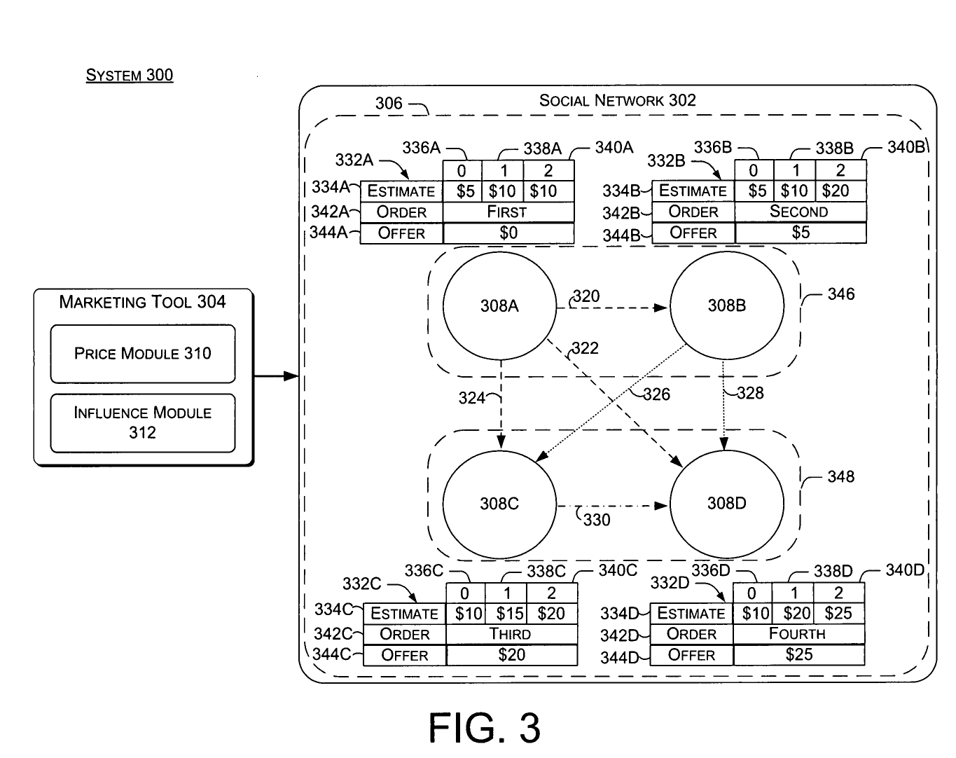

FIG. 3 involves another social marketing system 300 that considers overall revenue from the sale of a product. In this scenario, system 300 includes a social network 302 and a marketing tool 304. Social network 302 includes a set of members 306. In this case, the set entails four individual members 308A, 308B, 308C, and 308D. Further, marketing tool 304 includes a price module 310, and an influence module 312.

Consistent with FIGS. 1-2 influence data is indicated via arrowed lines. For instance, member 308A influences members 308B, 308C, and 308D as identified by dashed lines 320, 322, and 324 respectively. Similarly, member 308B influences members 308C and 308D as indicated by dotted arrows 326, 328 respectively. Finally, member 308C influences member 308D as indicated by dashed/dotted arrow 330. In this case, member 308D does not influence any other members.

Marketing tables are illustrated in FIG. 3 to explain some of the processing that can be performed by marketing tool 304 in this implementation. Table 332A is associated with member 308A, table 332B is associated with member 308B, table 332C is associated with member 308C, and table 332D is associated with member 308D. In the remainder of this paragraph numeric designators for the marketing tables are introduced generally with the alphabetic suffixes (A, B, C, and D) specific to individual member marketing tables. The first horizontal row 334 of the marketing tables reflects an estimated value of the product to the respective members in different scenarios. In this case, the scenarios relate to the estimated value of the product in light of how many other members have already purchased the product.

For example, sometimes products have features that aid social networking. For instance, Microsoft Corporation's music player, the Zune®, has a music sharing feature that allows it to wirelessly exchange music with other Zunes. The value of such a feature can be a function of the number of acquaintances who also own the product.

Numbers of members who have already purchased the product are indicated in the vertical columns 336, 338, 340. The second horizontal row 342 of the table relates to a relative order that the product is offered to the individual member. The third horizontal row 344 relates to an actual offer price generated by the marketing tool for the member.

For purposes of explanation consider table 332A associated with member 308A where these concepts are illustrated with specificity. In this case, horizontal row 334A shows the estimated perceived value of the product to the member. For instance, an intersection of horizontal row 334A and vertical column 336A indicates that where zero other members have purchased the product the estimated value to member 308A is “$5”. Similarly, an intersection of horizontal row 334A and vertical column 338A indicates that where one other member has purchased the product the estimated value to member 308A is “$10”. Finally, an intersection of horizontal row 334A and vertical column 340A indicates that where two other members have purchased the product the estimated value to member 308A is “$10”.

Horizontal row 342A relates to the order of offers and indicates that member 308A will receive the first offer. Rational for making the first offer to member 308A can be based at least in part on the relative influence of the members. In this case, member 308A influences every other member in the network as indicated by arrows 320, 322, and 324.

Horizontal row 344A relates to an offer price determined by marketing tool 304 for member 308A. Given that the first offer will be made to member 308A, one could conclude that the offer price would be five dollars as derived from horizontal row 304A. However, the offer price of horizontal row 344A is adjusted from the estimated perceived value based upon member 308A's relatively high level of influence on other members. In this case, the offer price is adjusted downwardly (i.e., reduced). This price adjustment can take into consideration a degree of certainty of the estimations of horizontal row 304A. Unless the estimation has a 100 percent degree of certainty that the member will accept the offer, there is some chance that member 308A would not buy the product at the estimated value. In this case, based at least on the relatively high influence of member 308A, the marketing tool decreases the offer price to reduce the chances that the member will reject the offer price. This example is an extreme case in that the marketing tool weighted the relative influence of member 308A so strongly that the price reduction was 100%. Viewed another way, the marketing tool sacrificed all revenue from the potential sale to member 308A in order to ensure that member 308A would buy or acquire the product and exert his/her influence on the remaining members. The basis for the offer price to member 308A becomes more apparent upon examination of each of the individual members and a summary of revenue from the entire social network 302.

A partial offer price reduction based upon influence is evidenced in relation to member 308B in table 332B. This member receives the second offer based upon his/her relative influence as indicated by horizontal row 342B. In this case, with member 308A having purchased the product, member 308B is estimated to have a perceived value of ten dollars as evidenced by the intersection of horizontal row 334B and column 338B. Instead, the marketing tool weights member 308B's relative influence and offers the product to member 308B at a reduced price of five dollars as evidenced from horizontal row 344B. In this case, the marketing tool determines that it is worth sacrificing some potential revenue from a sale to member 308B to increase a likelihood of member 308B actually making the purchase. However, the influence of member 308B is less than that of member 308A and at this point, member 308A already has the product and is influencing other members so the discount to member 308B is of a lower percentage than the discount reflected in the offer to member 308A.

As the discussion progresses to members 308C and 308D, the marketing tool's strategy has already increased a likelihood that influential members 308A and 308B have purchased the product and are influencing members 308C and 308D. Member 308C receives the third offer as indicated in horizontal row 342C of table 332C. Accordingly, the marketing tool 304 can offer the product to member 308C at an offer price indicated in row 314C of “$20” dollars. This price equals the estimated perceived value for member 308C where two other members have already purchased the product as evidenced by the intersection of column 340C and row 334C.

In the present example, member 308D receives the final offer as evidenced at row 342D of table 332D. The order of the offer can be based at least in part on the low (none) relative influence of member 308D. Further, in this case the offer price of row 344D is equal to the estimated value evidenced at the intersection of column 340D and row 334D. While only four members are illustrated in social network 302, the potential overall revenue advantages of increasing early adoption rates by influential members can become more pronounced as the number of members increases.

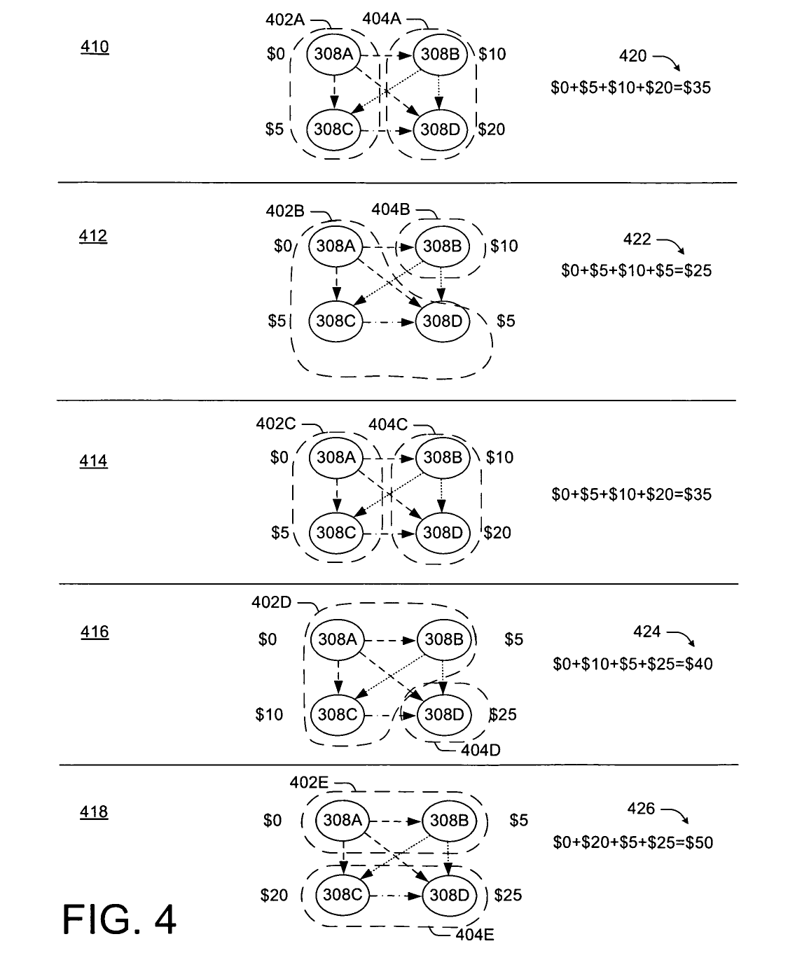

As mentioned above in relation to FIG. 1, one way to consider system 300 is that marketing tool 304 divides the members into two groups. A first group 346 can contain relatively highly influential members and the second group 348 can contain relatively less influential members. In this example, first group 346 contains members 308A and 308B while second group 348 contains members 308C and 308D. The marketing tool weights early adoption by the first group 346 and as such can discount offer prices to these members to increase adoption rates. The marketing tool weights revenue from the less influential members of second set 348 and as such the offer prices reflect the estimates of what these members are willing to pay for the product. An example of a technique for selecting members for the first and second groups is described below in relation to FIG. 4.

In summary, the present techniques can forgo some or all revenue from relatively influential members in order to promote early adoption by these members. Overall revenue from the social network can be increased due to the positive influence exerted on the behavior of the relatively less influential members in buying the product even though revenue from the relatively highly influential buyers may be reduced.

FIG. 4 shows a member identification technique 400 for distinguishing relatively highly influential members of a social network. In essence, a goal of the member identification technique is to put at least some relatively highly influential members in a first set of members. As mentioned above in relation to FIG. 3, offer prices to members of the first set can be discounted to increase the adoption rate by these relatively highly influential members. Offer prices to the second set can be weighted toward revenue from sales to those members who may be more likely to purchase the product (and/or at a higher price) thanks to early adoption by members of the first set.

Member identification technique 400 is introduced broadly here to illustrate the underlying inventive concepts. Specific implementations and algorithms for accomplishing member identification techniques are discussed below under the heading “Local Search”.

As illustrated, member identification technique 400 is employed on the four members 308A-308D of social network 300 introduced above in relation to FIG. 3. Five specific sequential configurations 410, 412, 414, 416 and 418 are addressed. In this discussion the first set is associated with designator 402 and is evidenced initially at 402A. The alphabetic suffix is subsequently changed to reflect changes in the composition of the first set. Similarly, the second set is associated with designator 404 and is evidenced initially at 404A. The alphabetic suffix is subsequently changed to reflect changes in the composition of the second set.

Initially, in first configuration 410 assume that technique 400 arbitrarily or randomly selects members for first set 402A with the remaining members forming the second set 404A. In this case, the randomly selected members of set 402A are members 308A and 308C. At this point, the technique estimates revenue from products sales to the members. As mentioned above, revenue from members of the first set tends to be lower due to lower offer prices to the first set. Remember that offer prices to members of the first set can be weighted toward encouraging purchases by sacrificing revenue. Correspondingly, revenue from members of the second set tends to be higher since offers to the second set tend to be driven by direct revenue and tend to disregard influence. In this discussion the estimated revenues generally, but not always, exactly correspond to those of FIG. 3.

In first configuration 410 estimated revenue from members 308A and 308C of first set 402A are assigned revenue numbers of “$0” and “$5” respectively. Members 308B and 308D of second set 404A are assigned revenue numbers of “$10” and “$20”, respectively. Accordingly, the overall estimated revenue from configuration 410 is “$35” as evidenced at 420.

In subsequent configuration 412 a member (308D) is selected at random and added to first set 402B from second set 404B. In this case, revenue from member 308D decrease from “$20” at time 410 to “$5” to reflect the likelihood that member 308D would likely be given a lower offer price as a member of set 402A. Since member 308D does not influence any other members, the remaining revenue remains the same. So, in configuration 412 overall estimated revenue drops from “$35” to “$25” as evidenced at 422.

Accordingly, technique 400 returns member 308D to the second set as evidenced by configuration 414 which is identical to configuration 410. Next, in configuration 416, the technique adds member 308B to first set 402C. In this configuration, estimated revenue from member 308B drops five dollars from “$10” to “$5”. However, due to the influence of member 308B estimated revenue from member 308C goes up five dollars from “$5” to “$10” and estimated revenue from member 308D goes up five dollars from “$20” to “$25”. Accordingly, the overall estimated revenue goes up five dollars from “$35” to “$40” as evidenced at 424. Therefore, technique 400 keeps member 308B in first set 402D.

Next, as evidenced in configuration 418, technique 400 randomly removes member 308C from the first set 402E. In this configuration, the estimated revenue from member 308C increases from “$10” to “$20” with no changes to other members. Thus, overall estimated revenue increases from “$40” to “$50” as evidenced at 426. Accordingly, the technique keeps member 308C in second set 404E. Technique 400 can repeat this process until overall estimated revenue is not increased by adding or removing individual members between the two sets. Further detailed discussion can be found below under the heading “Local Search”.

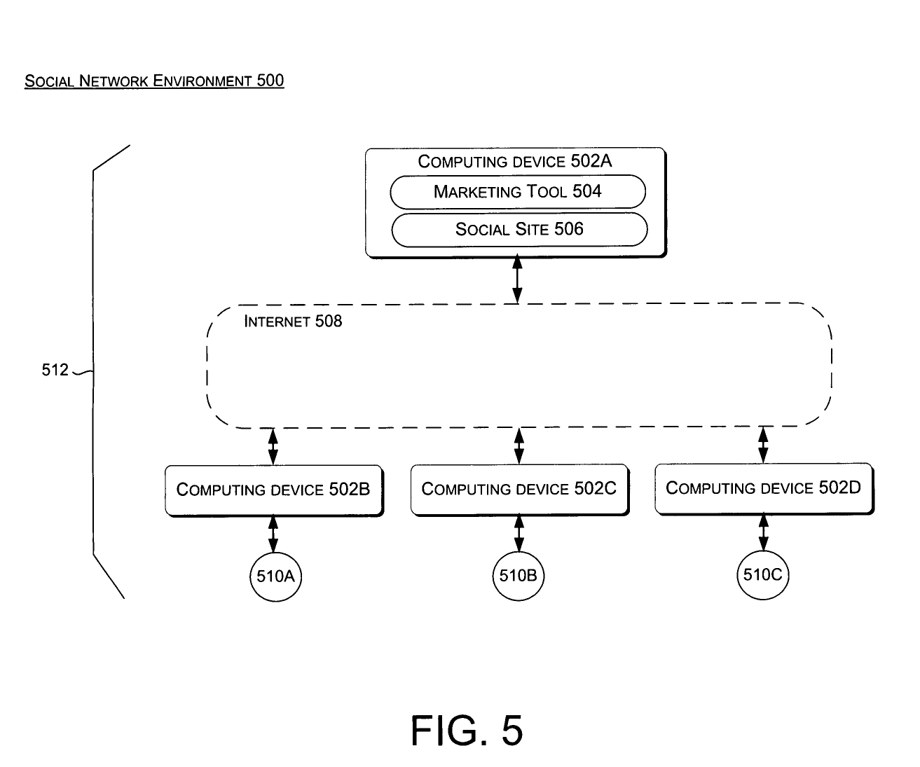

FIG. 5 shows an example of a basic social network operating environment 500. In this case, four computing devices 502A, 502B, 502C, and 502D are illustrated in social network operating environment 500, but the number of computing devices is immaterial to the present discussion. In this instance, computing device 502A includes a marketing tool 504. Examples of marketing tools are described above in relation to FIGS. 1-4. Computing device 502A also hosts a social site 506. In other configurations, the social site and marketing tool need not reside on a single computing device. Computing device 502A is communicatively coupled to the remaining computing devices 502B-502D via the Internet 508 or other network sufficient that the other computing devices can access social site 506.

Computing devices 502B, 502C, and 502D can function as nodes that allow members 510A, 510B, and 510C, respectively, to access social site 506. Thus, a social network 512 can be thought of as members 510A-510C themselves and/or the computing devices 502A-502D that enable the social network.

A computing device can be thought of as any digital device that is configured or configurable to communicate with other digital devices. Examples of computing devices can include personal computers and other brands or types of computers, personal digital assistants, cell phones, or any other of the ever evolving types of devices.

### Further Detailed Implementations

The following implementations include marketing strategies that consider revenue from the sale of digital products. In some instances, some of these implementations attempt to increase and even maximize revenue from the sale of digital products. The discussion assumes that there is a seller of a digital product and set V of potential buyers. The discussion further assumes that a buyer's decision to buy an item can be dependent on other buyers owning the item and the price offered to the buyer. Accordingly, for buyer i, the value of the buyer for the good is defined by a set function vi:2^{v}→R⁺. These functions model the influence that buyers have on other buyers. The discussion assumes that the seller does not know the value functions, but instead has distributional information about them. In general, smaller prices can increase the probability of sales.

The discussion considers marketing strategies where the seller considers buyers in some sequence and offers each buyer a price for the product. When the buyer accepts the offer, the seller earns the price of the item as the revenue. As a result, a marketing strategy has two elements: the sequence in which the product is offered to buyers, and the prices at which the product is offered. In general, it can be advantageous to get influential buyers to buy the item early in the sequence. It can even make sense to offer such buyers lower prices to get them to buy the item.

Symmetric Settings. The discussion starts by studying a symmetric setting where all the buyers appear (ex-ante) identical to the seller, both in terms of the influence they exert and their response to offers.

In such settings, the sequence in which to offer prices is immaterial and valuable pricing policy can be derived using dynamic programming. A valuable marketing strategy can demonstrate the following behavior: the probability of buyers accepting their offer can decrease as the marketing strategy progresses. Initially, the valuable marketing strategy can offer discounts in an attempt to get buyers to buy the product. This increases a perceived value that buyers, later in the sequence, have for the product. This allows the valuable strategy to potentially extract more revenue from subsequent buyers. In fact, early in the sequence the valuable strategy can even give away the item for free. In this context, a valuable marketing strategy can be considered a marketing strategy that at least addresses revenue and in some manifestations can attempt to increase and/or maximize revenue. In some implementations, the valuable marketing strategy can be considered an optimal marketing strategy in that it attempts to maximize revenue.

General Settings. Next, the discussion considers algorithms to find valuable marketing strategies in general settings. First, the discussion shows that finding the valuable marketing strategy is NP-Hard by reduction from the maximum feedback arc set problem. Accordingly, the discussion considers approximation algorithms as a substitute.

The discussion identifies a simple marketing strategy, called the influence-and-explore (IE) strategy. Recall that any marketing strategy tends to have two aspects: pricing and finding the right sequence of offers. In the initial influence step, motivated by the form of the valuable strategy in the symmetric case, the seller starts by giving the item away for free to a specifically chosen set of members A [symbol] V. In the explore step, the seller visits the remaining members (V\A) in a random sequence and attempts to increase and/or maximize the revenue that can be extracted from each member by offering the member the (myopic) valuable price; note that this effectively ignores the influence that members in the set V\A exert on each other. Note further, that in some implementations, the valuable price may be an optimum price for the member.

The discussion first shows that such strategies are a reasonable approximation of the valuable marketing strategy, which, by a hardness result is not polynomial-time computable in instances where the valuable marketing strategy seeks optimum pricing. This may be considered surprising because of the relative simplicity of influence-and-explore strategies, which only uses two prices (the price zero and the valuable (myopic) price and does not attempt to find the right offer sequence (it visits buyers in a random sequence).

This justifies studying the computational problem of finding the valuable influence-and-explore (IE) strategy. More specifically, discussion relates to finding a valuable IE strategy that may be an optimum. The discussion below specifies that if certain player specific revenue functions are submodular, then the expected revenue as a function of the set A is also submodular. The discussion below details a model that defines the dependence of adoption on influence and price. Further, this model makes it possible to discuss how many people the product should be given away to for a reduced price up to free.

Note that as mentioned above, some implementations can pay highly influential members to become early adopters. This particular case study is based on the premise that members will adopt the product if it is offered for free. Having said that, if there are negative valuations, the influential members can be paid to adopt the product.

Consider a seller who wants to sell a product to a set of potential buyers, V. The cost of manufacturing a copy of the product is nominal and the seller has an unlimited supply of the product. The discussion assumes that the seller is interested in addressing and potentially even maximizing its revenue.

For purposes of explanation, consider a selling strategy in the (standard) setting with no externalities. As members do not influence each other, the seller can consider each member separately. The discussion assumes that though the seller does not know the member's exact value (maximum willingness to pay), the seller does know the distribution F from which its values are drawn. F is the cumulative distribution of the member's valuation, i.e., F(t) is the probability the member's value is less than t.

Definition 1. Suppose that the member's value is distributed according to the distribution F. The optimal price p* maximizes the expected revenue extracted from member i, i.e., the price p* maximizes p·(1−F(p)). In this case, the optimal revenue can be p*·(1−F(p*)) (in expectation).

### Influence Model

The discussion now describes a general setting where the members influence each other; the discussion also lists concrete instances of this model. A member i's value for the product now depends on the set of buyers that already own the product. The value is determined by the function vᵢ:2^{v}→R⁺. Suppose this is a set S [symbol] V/{i}, then the value of member i is a non-negative number vᵢ(S). When the social network is modeled by a graph, vᵢ(·) is a function only of neighbors of i in the graph.

Again, as in the setting with no externality, the discussion assumes the member knows the distributions from which the values are drawn. Thus, the discussion treats the quantities vᵢ(·) as random variables. The seller knows the distributions of Fᵢ,s of the random variables vᵢ(S), for all S [symbol] V and for all i∈V. The following discussion assumes that members' values are distributed independently of each other. Listed below are some concrete instantiations of this model for discussion purposes:

### Uniform Additive Model

In the uniform additive model there are weights wᵢⱼ for all i,j∈V. The value vᵢ(S) for all i∈V and S [symbol] V/{i} is drawn from the uniform distribution └0,Σ_{j∈s ∪{i}}wᵢⱼ┘.

### Symmetric Model

In the symmetric model, the valuation vᵢ(S) is distributed according to a distribution Fₖ, where k=|S|. (Note that the identities of the member i and the set S do not play a role.)

### Concave Graph Model

In this model, each member i∈V is associated with a non-negative, monotone, concave function ƒᵢ:R⁺→R⁺. The value vᵢ(S) for all i∈V,S [symbol] V/{i}, is equal to ƒᵢ(Σ_{j∈S∪{i}}wᵢⱼ). Each weight wᵢⱼ is drawn independently from a distribution Fᵢⱼ. The distributions Fᵢ,s can be derived from the distributions Fᵢⱼ for all j∈S.

### Marketing Strategies

As discussed above, when members influence each other, the seller can conduct sales in an intelligent sequence and offer intelligent discounts so as to potentially optimize its revenue. In this section, the discussion formally describes the space of possible selling strategies.

A marketing strategy has the seller visiting members in some sequence and offering each member a price. Thus, a member can be thought of as a potential buyer. Each member either accepts (buys the item and pays the offered price) or rejects (does not buy and does not pay the seller) the product. In this particular implementation, the discussion assumes that each buyer is considered exactly once. Both the prices offered and the sequence in which members are visited can be adaptive, i.e., they can be based on the history of accepts and rejects. A marketing strategy thus identifies the next member to visit and the price to offer the member as a function of the history. Throughout this discussion, members are assumed to be myopic, i.e., they are influenced only by members who have already bought the product. At any point in time, if a set S of members already owns the product, the value of member i is vᵢ(S).

A run of a marketing strategy consists of a sequence of offers, one to each member in V along with the set of accepted and rejected offers. The revenue from the run is the sum of the payments from the accepted offers. A marketing strategy and the value distributions together yield a distribution over runs—this defines the expected revenue of the marketing strategy. The discussion calls a marketing strategy that considers and even potentially optimizes revenue, a valuable marketing strategy.

### An Upper Bound on Revenue

In this section, the discussion shows why using the optimal price of Definition 1 can be short-sighted. The discussion also derives an upper bound on the revenue of the valuable marketing strategy. Suppose that the seller visits a specific member i at some point in a run and a set S of members has already bought the good. The value of the member i is now distributed as Fᵢ,s. What price should the seller offer to the member? The discussion notes that optimal pricing (Definition 1) is no longer optimal; instead some implementations may want to offer the member a discount, so that the member buys the item and influences others. However, if the seller is myopic and ignores the member i's ability to influence other members then the seller might offer the optimal price. Motivated by the above, the discussion henceforth refers to the optimal price as the optimal (myopic) price.

The discussion finishes the section by deriving an upper bound on the revenue of the valuable marketing strategy in terms of certain member specific revenue functions. Let Rᵢ(S) be the revenue one can extract from member i, given that set S of members have bought the product using the optimal (myopic) price (See Definition 1). Naturally, Rᵢ is non-negative. The discussion assumes that the functions Rᵢ are monotone, i.e. for all i and A [symbol] B [symbol] V/i,Rᵢ(A)≦Rᵢ(B)); this implies that members only exert positive influence on each other. Monotonicity of the revenue functions implies the following upper bound on the revenue of the valuable marketing strategy.

Fact 1. The revenue of the valuable marketing strategy is at most Σ_{i∈V}Rᵢ(V).

Further assume that Rᵢ is submodular (for all i, for all A⊂V and B⊂V/{A},Rᵢ(A∪B)+Rᵢ(A∩B)≦Rᵢ(A)+Rᵢ(B)). Submodularity is the set analog of concavity: it implies that the marginal influence of one member on another member decreases as the set of members who own the product increases.

### Some Technical Facts

Several facts are listed here that are utilized in the discussion. First, the discussion repeatedly uses the following fact about monotone submodular functions.

Lemma 2.1. Consider a monotone submodular function ƒ:2^{V}→R and subset S⊂V. Consider random set S¹ by choosing each element of S independently with probability at least p. Then, E[ƒ(S¹)]≧p·ƒ(S).

Further, some of the results rely on the value distributions satisfying a certain monotone hazard rate condition. The discussion first defines the hazard rate function of a distribution.

Definition 2. The hazard rate h of a distribution with a density function f, distribution function F and support [a,b] is

$$h ( t ) = \frac{f ( t )}{( 1 - F ( t )} .$$

The distribution function can be expressed in terms of the hazard rate: F(t)=1−e^{-∫}^{ₐ}^{^{t}}^{h(x)dx}.

Definition 3. A distribution, with a density function f and distribution function F, satisfies the monotone hazard rate condition if, and only if, for any point t in the support,

$$h ( t ) = \frac{f ( t )}{1 - F ( t )}$$

is monotone non-decreasing.

The assumption that the values distribution satisfies the monotone hazard rate condition may be somewhat weak. Such an assumption is commonly employed in auction theory to model value distributions—several distributions such as the uniform, the exponential and the normal distribution satisfy this condition. For instance, the uniform distribution in the interval [0, 1] has a hazard rate

$$\frac{1}{1 - t} .$$

### Valuable Marketing Strategies

### Symmetric Settings

In this section, the discussion looks at symmetric settings and shows that the valuable marketing strategy can be identified based on a simple dynamic programming approach. This assumes that member values are defined according to the symmetric model from the previous section, where the member values are drawn from one of |V| distributions Fₖ.

The discussion now derives the valuable marketing strategy. As the model can be completely symmetric in the members, the sequence in which it visits members may be irrelevant. Further, the offered prices can be a function only of the number of members that have accepted and the number of members who have not, as yet, been considered. Let p(k, t) be the offer price to the member under consideration, used by the valuable marketing strategy, given that k members have bought the product and t members are not as yet considered (including the member currently under consideration); and R(k, t) is the maximum expected revenue that can be collected from these remaining members. The discussion now sets-up and solves a recurrence in terms of the variables p and R. This assumes that the density function of the distribution Fₖ,ƒₖ(S), exists.

Given a price p, if the member accepts, this implementation can collect the revenue of p+R(k+1, t−1), and if the member rejects, this implementation can collect revenue of R(k, t−1). Moreover, the member accepts if, and only if, its value is at least p, i.e., with probability 1−Fₖ(p).

As a result, this implementation sets the price p to potentially maximize the expected remaining revenue. For any price p, the expected remaining revenue is:

Fₖ(p)·R(k,t−1)+(1−Fₖ(p))·(R(k+1,t−1)+p)

The optimal price can be found by differentiating the above expression with respect to p and setting to 0:

ƒk(p)(R(k,t−1)−R(k+1,t−1)−p)+1−Fₖ(p)=0

The discussion can then set p(k, t) to the value which satisfies the above equation. The variable R(k, t) is now easy to compute. The above dynamic program can be solved in time quadratic in the number of members. For the base case, note that R(k, 0)=0. This defines the valuable (and potentially optimum) marketing strategy; note that this occurs as long as the density functions exist; there were no additional assumptions in the analysis. The discussion now transitions to the main result of this section.

Lemma 3.1. In the symmetric influence model, the optimal strategy can be computed in polynomial time.

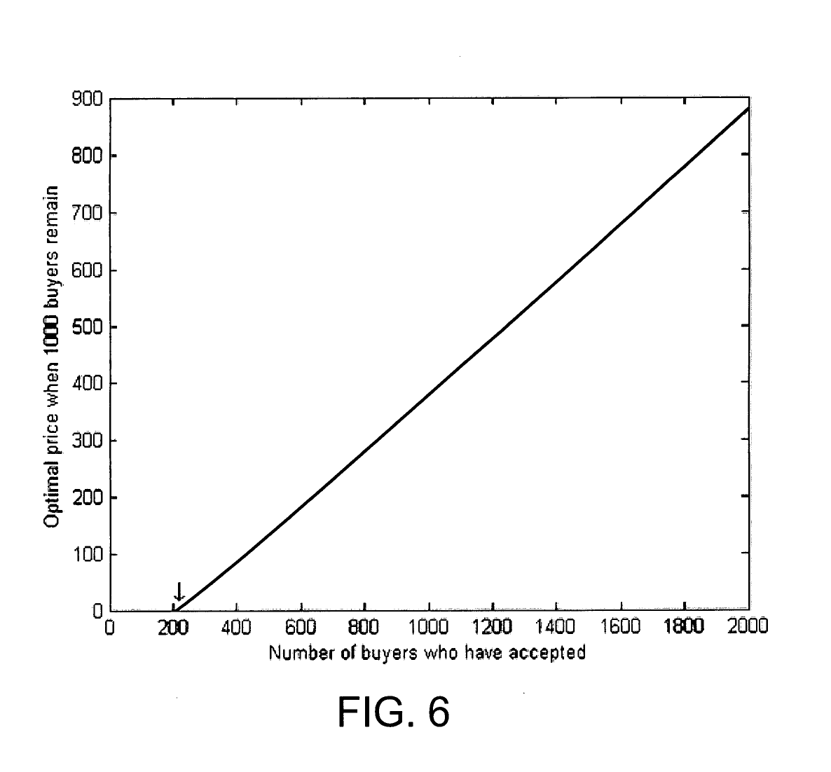

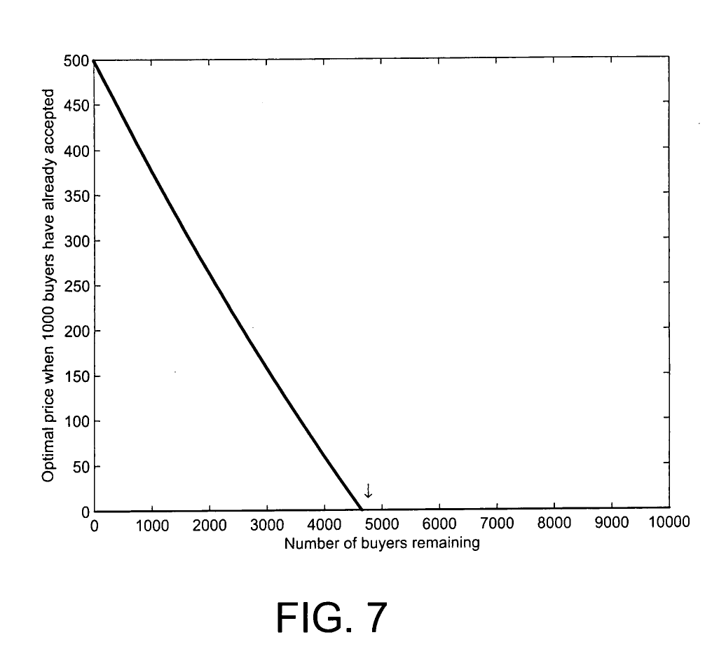

The discussion concludes the section by briefly investigating a concrete symmetric setting. Suppose the value of agent i with S served, vᵢ(S), is uniform [0, |S|+1]. (A symmetric setting where the distribution Fₖ is the uniform distribution on [0, k+1].) FIGS. 6 and 7 depict the variation in the optimal price as k and t vary; FIG. 6 confirms that for a fixed t, the potentially optimal price increases as the number of members who have already bought the item increases. FIG. 7 confirms that for a fixed k, as the number of members who remain goes up, it makes more sense to ensure that the member under consideration buys the good even if this means sacrificing the revenue earned from the member. Both monotonicity properties hold more generally. FIG. 7 also shows that at the beginning of the marketing strategy, when a large number of buyers remain in the market, the optimal price is potentially zero. This observation motivates studying the influence-and-explore marketing strategy.

Hardness

The discussion now considers the algorithmic problem of finding valuable (and potentially optimal) marketing strategies in general settings. In this section, the discussion shows that the problem of computing a potentially optimal strategy is NP-Hard, even when there is no uncertainty in the input parameters. In particular, the discussion assumes that the values vᵢ(S) are precisely known to the seller; all the distributions Fᵢ(S) are degenerate point distributions. In such a setting it is easy to see that the only problem is to find the right sequence of offers. Given any offer sequence, the prices to offer are clear; if a set S of members have previously bought, offer the next member i price vᵢ(S). This price simultaneously potentially extracts the maximum revenue possible and ensures that the member buys and hence exerts influence on future members. The discussion now shows that finding the optimal sequence is NP-Hard even when the values are specified by a simple additive model. Thus, consider the additive model where, vᵢ(S)=Σ_{j∈S∪{i}}wⱼᵢ.

Lemma 3.2. Finding the valuable (and potentially optimal) marketing strategy is NP-hard even with complete information about member values.

The above hardness result shows that even with full information about the members' values, computing the optimal ordering can be hard. Motivated by this hardness result, these implementations design and utilize approximately optimal marketing strategies that can be found in polynomial time. As the above reduction is approximation preserving to achieve better than ½-approximation for the problem, these implementations improve the approximation factor of the maximum feedback arc set problem. The potentially best approximation algorithm known for the maximum feedback arc set problem is a ½-approximation algorithm and it is long-standing open question to achieve better than ½-approximation for. As the present problem also involves the pricing aspect, some implementations operate satisfactorily by trying to get close to the benchmark of ½.

### Influence-and-Explore (IE) Marketing

Motivated by the hardness result mentioned above, the discussion now turns to designing polynomial-time algorithms that find approximately optimal marketing strategies. Recall that a marketing strategy broadly has two elements, the offer sequence and the pricing. The present implementations identify a simple, effective marketing strategy, called the influence-and-explore (IE) strategy. The discussion starts in relation to motivation for this strategy, then shows that it is effective in a very general sense and finishes by discussing techniques to find optimal strategies of this form. The discussion now motivates the structure of the IE strategy; the strategy has an influence step, which gives the item away for free, (or at a reduced price), to a judiciously selected set of members; followed by an explore step that is based on a random sequence of offers and a robust pricing strategy.

1. The valuable (and potentially optimal) marketing strategy in the symmetric setting started by giving the item away for free to a significant fraction of the players; this motivates the influence step.

2. The previous section noted that the potentially best known approximation algorithm for the maximum feedback arc-set problem is a ½-approximation. Surprisingly, picking a random sequence of nodes yields this (as each edge is selected with probability ½). Inspired by this realization, during the explore step, the present techniques visit buyers in a sequence picked uniformly at random.

3. At least some of the present implementations use potentially optimal (myopic) pricing (See Definition 1) in the explore step. Accordingly, these implementations attempt to maximize revenue extracted from a member, without worrying about the influence that the member exerts on others.

Some implementations of the IE Strategy are now described. The strategy has two steps:

1. Influence: Give the item free to members in a set A.

2. Explore: Visit the members of V\A in a sequence a (picked uniformly at random from the set of all possible sequences). Suppose that a set S [symbol] V/{i} of members have already bought the item before member i is made an offer. Offer member i the potentially optimal (myopic) price as a function of the distribution F_{iS}. Note that the optimal (myopic) price is adaptive, and is based on the history of sales.

By giving the product to the members of set A, no revenue is extracted from the set. However, the technique can essentially guarantee that these members accept the item and influence other members. This can allow the technique to extract added revenue from the set V\A of members that more than compensates for the initial loss in revenue. There are two issues. How good is the IE strategy compared to the optimal strategy? What set A maximizes revenue? The next two sections answer these questions.

### How Good are Influence-and-Explore (IE) Strategies?

Note that IE strategies can be fairly simple. For instance, some implementations only use two extreme prices and random orderings. This section shows that IE strategies compare favorably to the optimal revenue-maximizing strategy. Before stating improved approximation guarantees for various settings, the following fact is observed:

Remark 1. Given any set of submodular revenue functions Rᵢ, the expected revenue from the optimal IE strategy is at least ¼ of the optimal revenue.

Proof. This remark can be proven by taking the set A of the IE strategies to be a random subset of members where each member is chosen independently with probability ½. By Lemma 2.1, the expected revenue from this IE strategy is at least

$${\sum }_{i ∈ V / A} {R}_{i} ( A ) = {\sum }_{i ∈ V / A} \frac{{R}_{i} ( V )}{2} .$$

Since each member is in set V\A with probability ½, the expected revenue of this strategy is at least

$${\sum }_{i ∈ V} \frac{{R}_{i} ( V )}{4} .$$

By Fact 1, the expected revenue of this IE strategy is a ¼-approximation of the optimal revenue.

Now, the discussion proves several improved approximation guarantees for IE strategies for special classes of the problem. For the concrete setting studied at the end of symmetric setting section, it is possible to show that the potentially best IE strategy is a 0.94-approximation to the optimal revenue. The discussion can analyze the IE strategy in the undirected additive model (See influence model section). This shows that there exists an IE strategy that gives a ⅔-approximation algorithm for this problem. The discussion starts by stating an easy fact about such uniform distributions:

Fact 2. Suppose a buyer has value distributed uniformly in an interval [0, M], then the optimal (myopic) price is M/2, which is also the mean of the distribution. The optimal (myopic) revenue is M/4.

The discussion now describes the IE strategy. It is now specified that for the set A.

$$Let \frac{N = {\sum }_{i ∈ V} {w}_{ii}}{2} and \frac{E = {\sum }_{\{ ij \} , i \neq j} {w}_{ij}}{2} .$$

Let A be a random subset of nodes (i.e., members) where each node is sampled with probability q.

Theorem 1. In the undirected, additive model, IE with the set A constructed as above yields at least ⅔ of the maximum possible revenue.

Proof. The discussion starts by showing an upper-bound on the revenue that any strategy can attain. The upper bound is tighter than the bound from Fact 1. This technique uses the observation that only one of (wᵢᵢ+Σ_{j∈S}_{_{i−1}}wⱼᵢ), can contribute to the revenue. For any strategy, fix the order in which the sales happened. Even assuming that every member buys the product, by Fact 2 the revenue extracted from the ith bidder in the sequence is ¼·(wᵢᵢ+Σ_{j∈S}_{_{i−1}}wⱼᵢ). Here, Sₖ is the first k member in the ordering. Summing over the bidders indicates that the optimal revenue is at most ½(N+E/2). Let Tᵢ be the set of members who buy the item before member v. Tᵢ includes A, and a random subset of V\A. Thus, for any member v, a member u is in set Tᵢ with probability

$$q + \frac{( 1 - q )}{4} = \frac{1 + 3 q}{8} .$$

Thus, for any buyer

$$i ∈ V / AE [ {v}_{i} ( {T}_{i} ) ] = {w}_{ii} / 2 + {\sum }_{j \neq i} \frac{1 + 3 q}{8} {w}_{ji} ,$$

therefore the expected revenue is

$$i ∈ V / A is \frac{1}{2} E [ {v}_{i} ( {T}_{i} ) ] = \frac{1}{4} {w}_{ii} + {\sum }_{j \neq i} \frac{1 + 3 q}{16} {w}_{ji} .$$

Moreover, a buyer v is in set V\A with probability 1−q. As a result, the expected revenue of the above algorithm is at least

$$\frac{1}{2} {\sum }_{i ∈ V} ( 1 - q ) E [ {v}_{i} ( {T}_{i} ) ] = {\sum }_{i ∈ V} ( 1 - q ) ( \frac{{w}_{ii}}{4} + {\sum }_{j \neq 1} \frac{1 - 3 q}{16} wji ) = \frac{1}{4} {\sum }_{i ∈ v} ( 1 - q ) {w}_{ii} + {\sum }_{\{ i , j \} , j \neq 1} ( \frac{1 - 2 q - 3 {q}^{2}}{16} ) {w}_{ji}$$

Thus, the expected revenue is at least

$$\frac{1}{2} ( 1 - q ) N + ( \frac{1 - 2 q - 3 {q}^{2}}{8} ) E .$$

In order to maximize the expected revenue, this technique sets:

$$q = \frac{E - 2 N}{3 E} .$$

For this value of q, the expected revenue is at least

$$\frac{{( E + N )}^{2}}{6 E} \geq \frac{( {E}^{2} + N )}{6 E} \geq \frac{E}{6} + \frac{N}{3} .$$

This proves the theorem.

The discussion now shows that IE strategies compare favorably to the optimal strategy even in a fairly general setting—the revenue functions are submodular, monotone and non-negative and the value distributions satisfy the monotone hazard rate condition. The discussion starts by showing that if the value distribution satisfies the monotone hazard rate condition, the member accepts the optimal (myopic) price with a constant probability.

Lemma 4.1. If value distribution satisfies the monotone hazard rate condition, the member accepts the optimal (myopic) price with probability at least 1/e.

Proof. By Definition 2, 1−F(t)=e^{-∫}^{ₐ}^{^{t}}^{h(x)dx}. As Fi satisfies the monotone hazard rate condition, 1−F(t)≧e^{-∫}^{ₐ}^{^{t}}^{h(x)dx}. At the optimal price, technique determines that 1/t=h(t). So

$$1 - F ( x ) \geq {e}^{- {\int }_{a}^{t} 1 / t d x} = {e}^{\frac{t - a}{t}} \geq 1 ,$$

as e^{x} is a monotone function.

The present discussion now uses the above lemma to prove the following theorem.

Theorem 2. Suppose that the revenue functions Rᵢ(S), for all i∈V and S [symbol] V/{i} are monotone non-negative and submodular and the distributions F_{i,S} for all i∈V and S [symbol] V/{i} satisfy the monotone hazard rate condition. Then there exists a set A for which the IE strategy is

$$a \frac{e}{4 e - 2} \text{-}$$

approximation of the optimal marketing strategy.

Proof. Let A be a random subset of members where each member is picked with probability p. Consider the IE strategy for this set A. For a member i∈V/A, let Tᵢ be the random subset of members who have bought the item before member i. Each member j is in V\A with probability 1−p, it appears before i with probability ½, and in this case, j buys the item by probability at least 1/e, thus, each member j∈V/A is in set Tᵢ with probability at least

$$\frac{1 - p}{2 e} .$$

Also each member j is in A with probability p in which j∈Tᵢ as well. As a result, each member j∈V is in Tᵢ with probability at least

$$p + \frac{1 - p}{2 e} .$$

Let Rᵢ be the expected revenue from member i in this algorithm. Then, by monotonicity and submodularity of the expected revenue function Rᵢ, and by Lemma 2.1, the expected revenue from Tᵢ is at least

$$( p + \frac{1 - p}{2 e} {R}_{i} ( V ) .$$

Thus, the expected revenue from this algorithm is at least

$$( p + \frac{1 - p}{2 e} {\sum }_{i ∈ V / A} {R}_{i} ( V ) .$$

Since each member i is in V\A with probability 1−p, the expected revenue from the IE strategy is at least

$$( 1 - p ) ( p + \frac{1 - p}{2 e} ) {\sum }_{i ∈ V} {R}_{i} ( V )$$

which is maximized by setting

$$p = \frac{e - 1}{2 e - 1} .$$

The theorem follows from Fact 1.

### Finding Influence-and-Explore Strategies

In the previous section, the discussion showed that in various settings influence and explore (IE) strategies approximate the optimal revenue within a reasonable constant factor. Motivated by this, the discussion attempts to find good IE strategies in more general settings. What set A of members should initially be given the item for free so that the revenue from the subsequent explore stage is maximized? In other words, these techniques want to find a set A that increases (and potentially maximizes) g(A) where g(A) is the expected revenue of the IE strategy when the item is given for free to set A in the first step. Though these techniques do not compute optimal set A, they compute an A that gives a good approximation. The main result of this section is the following:

Theorem 3. There is a deterministic polynomial-time algorithm that computes a set A, such that the revenue of the IE strategy with this set yields at least a ⅓-fraction of the revenue of the optimal IE strategy. Moreover, there exists a randomized polynomial-time 0.4-approximation algorithm for the potentially optimal IE strategy.

The deterministic algorithm mentioned in the above theorem is now described. The deterministic algorithm is based on a local search approach.

### Local Search

1. Initialize set A={v} for the singleton set {v} with the maximum value g({v}) among singletons.
2. If neither of the following two steps apply (there is no local improvement), output the better of A and A.
3. For any member i∈V/A, if

$$g ( A ⋃ \{ i \} ) ≻ ( 1 + \frac{e}{{n}^{2}} ) g ( A )$$

adding an element to A increases revenue), then set A:=A∪{i} and go to 2.
4. For any buyer i∈A, if

$$g ( A / \{ i \} ) ≻ ( 1 + \frac{e}{{n}^{2}} ) g ( A )$$

(deleting an element from A increases revenue), then set A:=A\{i} and go to 2.

Since at each step of the local search algorithm, the expected revenue improves by a factor of

$$( 1 + \frac{e}{{n}^{2}} ) ,$$

and the initial value of g(A) is at least 1/n of the maximum value, the number of local improvements of this algorithm is at most log

$${}_{( 1 + \frac{e}{{n}^{2}} )} n = O ( \frac{{n}^{3}}{∈} ) .$$

This is also an explanation for why the algorithm necessarily terminates. Further, these techniques can compute g(A) for any set A in polynomial time by sampling a polynomial number of scenarios, and taking the average of the function for these samples. This shows that the above algorithm runs in polynomial time.

Lemma 4.2. Suppose the set function g(·) is non-negative and submodular. Let M be the maximum value of the submodular set function. Then the deterministic local search algorithm finds a set A such that

$$g ( A ) \geq \frac{1}{3} M .$$

More-over, there exists a randomized local search algorithm that finds a set A such that

$$g ( A ) \geq \frac{2}{5} M .$$

Given the above theorem, to complete the proof of Theorem 3, it is sufficient to show that the function g(A) is non-negative and submodular. In order to prove submodularity of function g, the discussion uses the following facts about submodular functions.

Fact 3. If f and g are submodular, for any two real numbers α and β, the set function h:2^{V}→R where h(S)=αƒ(S)+βg(S) is also submodular. The set function h where h(S)=f(V\S) is submodular. For a fixed subset T⊂V, function h where h(S)=ƒ(S∪T) is also submodular.

The discussion now shows that under certain conditions on the revenue functions Rᵢ for i∈V, the set function g(A) is a nonnegative submodular function.

Lemma 4.3. If all the revenue functions Rᵢ for i∈V are non-negative, monotone and submodular, then the expected revenue function g(A)=Σ_{i∈V/A}Rᵢ(A) is a non-negative submodular set function.

Proof. It is easy to see that g is non-negative for all i. The discussion focuses on proving that g is submodular: thus it is desired to prove that for any set A [symbol] V and C [symbol] V:

g(A)+g(C)≧g(A∪C)+g(A∩C),

First, using monotonicity of Rᵢ, for each i∈(A/C)∪(C/A):

$${\sum }_{i ∈ A / C} {R}_{i} ( C ) + {\sum }_{i ∈ C / A} {R}_{i} ( A ) \geq {\sum }_{i ∈ A / C} {R}_{i} ( A ⋂ C ) + {\sum }_{i ∈ C / A} {R}_{i} ( A ⋂ C ) \qquad ( 1 )$$

Now, using submodularity of Rᵢ, for each i∈V/A(A∪C),

Rᵢ(A)+Rᵢ(C)≧Rᵢ(A∪C)+Rᵢ(A∩C).

Therefore, summing the above inequality for all i∈V/(A∪C), produces:

$${\sum }_{i ∈ V / ( A ⋃ C )} {R}_{i} ( A ) + {\sum }_{i ∈ V / ( A ⋃ C )} {R}_{i} ( C ) \geq {\sum }_{i ∈ V / ( A ⋃ C )} {R}_{i} ( A ⋃ C ) + {\sum }_{i ∈ v / ( A ⋃ C )} {R}_{i} ( A ⋂ C )$$

Summing equations 1, 2,

$${\sum }_{i ∈ V / A} {R}_{i} ( A ) + {\sum }_{i ∈ V / C} {R}_{i} ( C ) \geq {\sum }_{i ∈ V / ( A ⋃ C )} {R}_{i ( A ⋃ C )} + {\sum }_{i ∈ V / ( A ⋂ C )} {R}_{i} ( A ⋂ C ) ,$$

This proves the result.

### Discussing the Model

This section discusses the validity of the modeling assumptions made in paragraphs 39-68. First, the concave graph model introduced above is discussed. After justifying the concave graph model, the discussion shows that it satisfies the submodularity and the monotone hazard assumptions from the previous section.

Recall that in this model the uncertainty is in the influence that a buyer has on another buyer and the influences are combined using buyer specific concave functions. The concavity models the diminishing returns that one expects the influence function to have. Such concave influence functions have another implication: once sufficiently many buyers have bought the item, it is easy to see that additional sales have little influence. From this point on it is potentially optimal to use optimal (myopic) prices. In particular, if buyers are relatively symmetric, optimal (myopic) pricing can be implemented via a posted price.

It is possible to use the link structure of online social networks to estimate wᵢⱼ. In practice, some implementations could reduce the parameters that need to learn by making intelligent symmetry assumptions. For instance, it might be reasonable to assume that there are two categories of buyers, buyers who wield considerable influence (opinion leaders) and other buyers.

The discussion now addresses the validity of the assumptions made about the player specific revenue functions, namely non-negativity, monotonicity and submodularity. Non-negativity is obvious. Monotonicity follows from the non-negativity of the weights and the non-negativity and monotonicity of ƒᵢ.

The discussion now shows that the means of the values, vᵢ(·), are submodular.

Lemma 5.1. In the concave graph model, the expected value of the random variable vᵢ(S), v̅ᵢ(S) is a monotone, non-negative, submodular set function.

Proof. Fix a buyer i. Condition on the values of the random variables wᵢⱼ. For any subsets S [symbol] S′ [symbol] V and buyer k not in S′, these techniques claim that:

(vᵢ(S∪{k})−vᵢ(S′))−(vᵢ(S′∪{k})−vᵢ(S′))≧0

This follows from the concavity of ƒᵢ. Thus the function vᵢ(·) is point-wise submodular. The discussion can now use Fact 3 to complete the proof.

Though the discussion may not quite prove that the player-specific revenue functions are submodular, (essentially revenue does not allow for a simple point-wise argument as above), implementations can be based on the supposition that this is true; it is easy to prove the conjecture in a setting where, for a fixed buyer i, the random variables vᵢ(S) for all S [symbol] V/{i} are identically distributed up to a scale factor; note that this is a generalization of the additive model described above.

The discussion now addresses why it is reasonable to assume that the value distributions satisfy the monotone hazard rate condition. First, in many situations, a significant fraction of the value of a buyer i can be expected to be independent of external influence (wᵢᵢ dominates wᵢⱼ for i≠j); in such cases the monotone hazard rate assumption is commonly made in auction theory. Second, by the well-known Central Limit Theorem, the sum of the independently distributed influence variables (wᵢⱼs for some fixed i) will be approximately like a normal distribution, so long as the variables are roughly identically distributed. It is known that the normal distribution satisfies the monotone hazard rate condition. Finally, the following closure properties of the monotone hazard rate condition can be used to show that if the distributions Fᵢⱼ satisfy the monotone hazard condition, then so do the value distributions Fᵢ,s.

Lemma 5.2. Fix an arbitrary buyer i∈V. In the concave graph model, if the distributions Fᵢⱼ satisfy the monotone hazard rate condition for all j, then for all sets S [symbol] V, the distributions Fᵢ, s satisfies the monotone hazard rate condition.

The discussion uses a lemma that formalizes the fact that the distribution of the sum of the random variables is only better concentrated than the distributions of the individual variables.

Lemma 5.3. The monotone hazard rate condition is closed under addition in the following sense. For any set of random variables aⱼ, if each aⱼ is drawn from a distribution that satisfies the monotone-hazard-rate condition, then the random variable Σⱼaⱼ also satisfies the monotone hazard rate condition.

The next lemma shows that the monotone hazard rate condition is closed under the application of a monotone function.

Lemma 5.4. If a random variable a is drawn from a distribution (with cumulative distribution function F and density function f) that satisfies the monotone hazard rate condition, then the random variable h(a) (with distribution Fh and a density function fh) also satisfies the monotone hazard rate condition, so long as h is strictly increasing.

The proof of Lemma 5.2 is finished here. By Lemma 5.3, the random variable Σ_{i∈S∪{i}}wᵢⱼ, satisfies the monotone hazard rate condition. By Lemma 5.4, and as ƒᵢ is increasing, provides the proof.

Finally, though the discussion throughout the specification assumes that optimal myopic prices can be calculated, it is noted that it is also reasonable to use mean values instead. The IE strategy thus modified will continue to give a constant factor approximation, though the constant is somewhat worse. The key lemma (Lemma A.1) which makes this possible is stated in the below; this lemma plays the role of Lemma 4.1.

Proof of Lemma 2.1.

Proof. Fix an ordering σ of the elements of the set S. This can be written as f(S) as the sum Σ_{1≦i≦|s|}ƒ(Sᵢ)−ƒ(Sᵢ₋₁). Here Sᵢ consists of the first i elements of the set S and the discussion assumes that f(S₀)=0. Recall the definition of the set S′ from the lemma statement. Using linearity of expectations, it follows that:

$$E [ f ( {S}^{′} ) ] = E [ {\sum }_{1 \leq i \leq \vert {S}^{′} \vert} f ( {S}_{i - 1}^{′} ) ] \geq {\sum }_{1 \leq i \leq \vert S \vert} p \cdot ( f ( {S}_{i} ) - f ( {S}_{i - 1} ) ) = p \cdot f ( S )$$

The second inequality uses the submodularity of f.

Proof of Lemma 3.2.

Proof. The discussion now shows how to reduce any instance of the NP-Hard maximum feedback arc set problem to the present problem. This establishes that the present problem is also NP-Hard and a polynomial time solution to the present problem cannot be achieved unless P=NP.

In an instance of the maximum feedback arc set problem, given an edge-weighted directed graph, the discussion orders the nodes of the graph to maximize the total weight of edges going in the backward direction in the ordering. The reduction is now described.

Let the nodes of the graph be the set of buyers. The edge weights are the weights wij . Let wᵢⱼ equal 0 for edges absent. The technique now defines the pricing. Given the ordering in which to offer buyers, the technique offers prices equal to the player's value; for a player i it is Σ_{j∈S∪{i}}wᵢⱼ, where S is the set of nodes visited before i. Given any ordering α, the revenue from such pricing is equal to the weight of the feedback arc set when the nodes in the graph are ordered in the reverse of α. Thus finding the optimal marketing strategy is equivalent to computing the maximum feedback arc-set.

The above proof shows the importance of constructing the right offer sequence. The discussion now observes that even in settings in which the influence is bidirectional, but the buyer has incomplete information, the offer sequence matters. For example, consider the additive model corresponding to a star graph of n buyers. Suppose that wᵢᵢ is 0, wᵢⱼ, j≠i is 0 if neither i or j is the center; and wᵢⱼ is drawn from the uniform distribution on the interval [0, 1], otherwise. The discussion finds that the optimal marketing strategy starts at the center and offers it a carefully calculated price; then it offers the remaining buyers the optimal (myopic) price. Somewhat surprisingly, if instead complete information was available, the offer sequence does not matter. The example shows that incomplete information makes the offer sequence important.

Lemma A.1. A buyer, whose value is distributed according to a distribution that satisfies the monotone hazard rate condition, accepts an offer price equal to the mean value with probability at least 1/e.

Proof. Fix the set S of buyers who already own the item and the buyer under consideration, i. Let f and F be the density and distribution functions for the buyer's value vᵢ(S). By Definition 2, the technique can write log(1−F(x))=−∫ₐ^{x}h(t)dt. As h(t) is non-decreasing in t, log(1−F(x)) is concave. Now, using Jensens inequality, log(1−F(μ))≧∫₀^{∞} log(1−F(x))dF(x)=∫₀¹ log(1−y)dy≧−1. (Replacing F(x) by y.) Taking the exponent on both sides completes the proof.

Proof of Lemma 3.2.

Proof. Because the function h is strictly increasing, the inverse function h−1 is defined. So for all t,

$$\frac{{f}_{h} ( t )}{1 - {F}_{h} ( t )} = \frac{f ( {h}^{- 1} ( t ) )}{1 - F ( {h}^{- 1} ( t ) )}$$

Thus, the monotone hazard rate condition is satisfied for the random variable h{tilde over (()}a) if, and only if, for all t and e>0,

$$\frac{f ( {h}^{- 1} ( t ) )}{1 - F ( {h}^{- 1} ( t ) )} \leq \frac{f ( {h}^{- 1} ( t + e ) )}{1 - F ( {h}^{- 1} ( t + e ) )} ,$$

but this is true as the random variable a satisfies the monotone hazard rate condition.

### Exemplary Methods

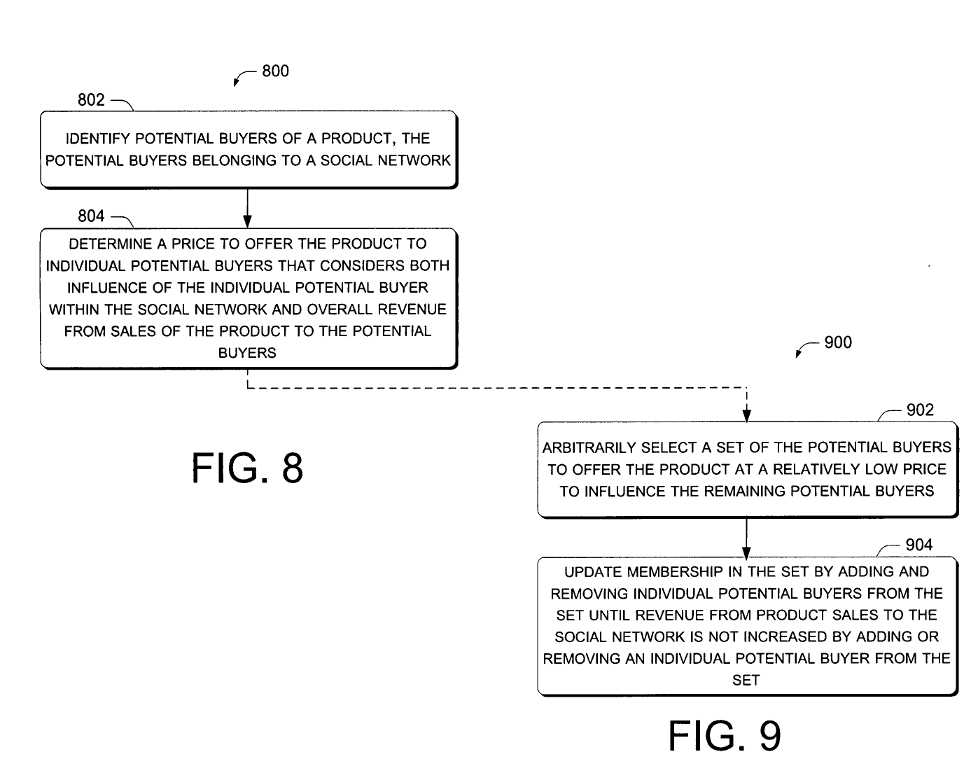

FIG. 8 illustrates a flowchart of a method or technique 800 that is consistent with at least some implementations of the present concepts. The order in which the technique 800 is described is not intended to be construed as a limitation, and any number of the described blocks can be combined in any order to implement the technique, or an alternate technique. Furthermore, the technique can be implemented in any suitable hardware, software, firmware, or combination thereof such that a computing device can implement the technique. In one case, the technique is stored on a computer-readable storage media as a set of instructions such that execution by a computing device causes the computing device to perform the technique.

Block 802 identifies potential buyers of a product; the potential buyers belonging to a social network. In essence, members of a social network can be considered potential buyers. When offered the product an individual member either buys the product or declines to buy the product and is a non-buyer.

Block 804 determines a price to offer the product to individual potential buyers that considers both influence of the individual potential buyer within the social network and overall revenue from sales of the product to the potential buyers. Some implementations can operate under the premise that there is some inverse relationship between the offer price and the probability of acceptance. Some implementations determine both an offer price for individual members and an order in which the offers should be made. Early purchase or adoption of the product by relatively highly influential members can have a positive effect on the perceived value of the product to other less influential members who then may be willing to pay more for the product. Thus, offer order can start with more influential buyers and progress to less influential buyers. Further, since adoption by the relatively highly influential members can increase revenue from other members, the offers to the relatively highly influential members can be discounted to increase the probability that they will accept the offer. Offers to other members can be weighted toward direct revenue from those members.

Once an offer price is determined, the method can cause the offer to be presented to the individual member. For instance, in an Internet based social network an electronic message or advertisement can be sent to the member that presents the offer price.

Examples of systems capable of implementing technique 800 are described above in relation to FIGS. 1 and 3. One technique for implementing block 804 can be termed influence-and-explore (IE) and is described below in relation to FIG. 9.

FIG. 9 illustrates a flowchart of another method or technique 900 that is consistent with at least some implementations of the present concepts. The order in which the technique 900 is described is not intended to be construed as a limitation, and any number of the described blocks can be combined in any order to implement the technique, or an alternate technique. Furthermore, the technique can be implemented in any suitable hardware, software, firmware, or combination thereof such that a computing device can implement the technique. In one case, the technique is stored on a computer-readable storage media as a set of instructions such that execution by a computing device causes the computing device to perform the technique. One implementation of technique 900 is described above by way of example in relation to FIG. 4.

Block 902 arbitrarily selects a set of the potential buyers to offer the product at a relatively low price to influence the remaining potential buyers.

Block 904 updates membership in the set by adding and removing individual potential buyers from the set until revenue from product sales to the social network is not increased by adding or removing an individual potential buyer from the set. Thus, the set can be thought of as the “influence” set. The remainder can be thought of as the “explore” set. Pricing to the influence set is weighted toward encouraging purchases (i.e., adoption) so that the members of the influence set are likely to adopt the product and positively influence member of the explore set. Pricing to the explore set can be weighted to increasing revenue from members of that set. Thus, some or all revenue from sales to the influence set can be sacrificed in the hope that the decrease in revenue will be more than offset by revenue from sales to the explore set. Accordingly, overall revenue, as the combined revenue from the influence and explore sets, can be higher than would otherwise be the case.

One technique for determining pricing for the members of the explore sub-set is described above in relation to FIG. 2 and further details are available in the “further detailed implementations” section under the heading “symmetric settings”.

### CONCLUSIONS

The above described concepts address revenue in social marketing. Considering both price and influence, implementations can determine an order to offer a product to social network members and offer prices for individual members to increase overall revenue from sales to the social network. Although techniques, methods, devices, systems, etc., pertaining to installing customized applications are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A method, comprising:
identifying potential buyers of a product, the potential buyers belonging to a social network; and,
determining a price to offer the product to individual potential buyers that considers both influence of the individual potential buyer within the social network and overall revenue from sales of the product to the potential buyers.

2. The method of claim 1, wherein the identifying comprises identifying potential buyers where the social network is an Internet-based social network.

3. The method of claim 1, wherein the product is a digital product of which additional copies can be produced at a nominal cost.

4. The method of claim 1, wherein the determining comprises dividing the potential buyers into a first set of relatively highly influential potential buyers and a second set of relatively less influential potential buyers.

5. The method of claim 4, wherein the determining comprises discounting offer prices to potential buyers of the first set to increase a probability of acceptance of the offer prices.

6. The method of claim 4, wherein the determining comprises selecting offer prices to potential buyers of the second set to increase revenue from the second set.

7. The method of claim 1, wherein the determining includes determining a reduced initial price for relatively highly influential potential buyers and a higher subsequent price for relatively less influential buyers.

8. The method of claim 1, wherein the determining considers both forward looking and rearward looking influence of the individual potential buyer.

9. The method of claim 1, wherein the determining comprises adding an individual potential buyer to a set of influential potential buyers that are initially offered the product at a discount and then calculating an effect on overall revenue from product sales to the remaining potential buyers.

10. The method of claim 1, further comprising causing the product to be offered to individual potential buyers at the price.

11. A computer-readable storage media having instructions stored thereon that when executed by a computing device cause the computing device to perform acts, comprising:
identifying social network members that are potential buyers of a digital good; and,
determining a price to offer the digital good to an individual social network member based upon a number of other social network members that have already purchased the digital good.

12. The computer-readable storage media of claim 11, wherein the identifying comprises identifying a first set of relatively highly influential social network members and a second set of relatively less influential social network members.

13. The computer-readable storage media of claim 12, wherein the determining comprises determining the price for social network members within the first and second sets without regard to influence.

14. The computer-readable storage media of claim 11, wherein the determining comprises employing dynamic programming.

15. A method, comprising:
identifying potential buyers of a product in a social network;
arbitrarily selecting a set of the potential buyers to offer the product at a relatively low price to influence the remaining potential buyers; and,
updating membership in the set by adding and removing individual potential buyers from the set until revenue from product sales to the social network is not increased by adding or removing an individual potential buyer from the set.

16. The method of claim 15, wherein the relatively low price is zero such that the product is offered to the potential buyers of the updated set for free.

17. The method of claim 15, wherein the updating is accomplished with a local search algorithm.

18. The method of claim 17, wherein the local search algorithm considers influence of individual potential buyers from both a forward looking perspective and a rearward looking perspective.

19. The method of claim 17, wherein the local search algorithm determines a local optimum such that revenue from product sales cannot be increased by adding or removing another individual potential buyer from the set.

20. The computer-readable storage media of claim 15, wherein the updating comprises determining offer prices to potential buyers that are not in the set without considering influence.
